(19) United States
(12) Patent Application Publication
(10) Pub. No.: US 2019/0251884 A1
(43) Pub. Date: Aug. 15, 2019

(54) SHARED CONTENT DISPLAY WITH CONCURRENT VIEWS

(71) Applicant: Microsoft Technology Licensing, LLC, Redmond, WA (US)

(72) Inventors: Aaron Mackay Burns, Sunnyvale, CA (US); John Benjamin HESKETH, Kirkland, WA (US); Donna Katherine LONG, Redmond, WA (US); Jamie Ruth CABACCANG, Bellevue, WA (US); Kathleen Patricia MULCAHY, Seattle, WA (US); Timothy David KVIZ, Seattle, WA (US)

(21) Appl. No.: 15/896,498

(22) Filed: Feb. 14, 2018

(51) Int. Cl. G09G 1/00; G09G 5/42

(52) U.S. Cl. CPC G09G 1/007; G09G 2340/0464; G09G 5/42

(57) ABSTRACT

In many computing scenarios, multiple users share a display to view and/or interact with content. Typically, one user provides input that interacts with the content; a second user can interact with the view only if the first user cedes control. Some interfaces permit split views, but typically support only a single input device that manipulates both panes. In the present disclosure, when a second user desires a different view of content during the first user's interaction, the device inserts a second view of the content into the display. Each view is associated with and manipulated by a particular user (e.g., via input devices associated with individual users) without altering the views of other users. The device may automatically manage the concurrent views, such as positioning and resizing; reflecting each user's perspective in other users' views; merging content changes; and terminating a view due to idleness or merging with another view.

### BACKGROUND

Within the field of computing, many scenarios involve a presentation of content that is concurrently viewed by multiple users. As a first example, a group of users may view content together on a display, such as a projector coupled with a projector screen or a very large LCD, where a selected user operates an input device on behalf of the group. As a second example, users may utilize different devices to view content together, such as a concurrently accessible environment on behalf of each individual, or a shared desktop of one user that is broadcast, in a predominantly non-interactive mode, to other users.

Such scenarios may provide various interfaces between the users and the content. As a first example, a display may be shared (locally or remotely) by a first user to other users, where the first user controls a manipulation of a view, such as the scroll location in a lengthy document, the position, zoom level, and orientation in a map, or the location and viewing orientation within a virtual environment. The first user may hand off control to another user, and the control capability may propagate among various users. Multiple users may provide input using various input devices (e.g., multiple keyboards, mice, or pointing devices), and the view may accept any and all user input and apply it to alter the view irrespective of the input device through which the input was received.

As a second example, a group of users may utilize a split-screen interface, such as an arrangement of viewing panes that present independent views of the content, where each pane may accept and apply perspective alterations, such as scrolling and changing the zoom level or orientation within the content. The operating system may identify one of the panes as the current input focus and direct input to the pane, as well as allow a user to change the input focus to a different pane. Again, multiple users may provide input using various input devices (e.g., multiple keyboards, mice, or pointing devices), and the view may accept any and all user input and apply it to the pane that currently has input focus.

As a third example, a set of users may each utilize an individual device, such as a workstation, laptop, tablet, or phone. Content may be independently displayed on each individual's device and synchronized, and each user may manipulate an individual perspective over the content.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A set of users who view content together on a display may prefer to retain the capability for individual users to interact with the content in an independent manner. For example, while the user set interacts with a primary view of the content, a particular individual may prefer a separate view with which the user may interact, e.g., by altering the position or orientation of the perspective or by inserting new content. The user may prefer to do so using the same display as the other users. Additionally, because such choices may be casual and ephemeral, it may be desirable to utilize an interface that permits new views to be created easily for each user, as well as easily terminated when a user is ready to rejoin the set of users in viewing the content.

Presented herein are techniques for presenting content to a set of users on a shared display that facilitates the creation, use, and termination of concurrent views.

In a first embodiment of the presented techniques, a device initiates a presentation comprising a group view of the content. The device receives, from an interacting user selected from the at least two users, a request to alter the presentation of the content, and inserts into the presentation an individual view of the content for the interacting user. The device also receives an interaction from the interacting user that alters the presentation of the content, and applies the interaction to the individual view of the content while refraining from applying the interaction to the presentation of the content in the group view.

In a second embodiment of the presented techniques, a device initiates, on a display, a view set of views that respectively display a presentation of the content. The device receives an interaction that alters the presentation of the content, and responds in the following manner. The device identifies, among the users, an interacting user who initiated the interaction. Among the views of the view set, the device identifies an individual view that is associated with the interacting user, and applies the interaction to alter the presentation of the content by the individual view while refraining from applying the interaction to the presentation of the content by other views of the view set.

A third embodiment of the presented techniques involves a device that presents content to at least two users. The device comprises a processor and a memory storing instructions that, when executed by the processor, provide a system that causes the device to operate in accordance with the presented techniques. For example, the system may include a content presenter that initiates, on a display, a presentation comprising a group view of the content, and that responds to a request, from an interacting user selected from the at least two users, to alter the group view of the content by inserting into the presentation an individual view of the content for the interacting user. The system may also include a view manager that receives an interaction from the interacting user that alters the presentation of the content, and applies the interaction to the individual view of the content while refraining from applying the interaction to the presentation of the content in the group view.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of a first example scenario featuring a presentation of content to users of a shared display.

FIG. 2 is an illustration of a second example scenario featuring a presentation of content to users of a shared display.

FIG. 3 is an illustration of an example scenario featuring a presentation of content to users of different displays.

FIG. 4 is an illustration of an example scenario featuring a presentation of content to users of a shared display in accordance with the techniques presented herein.

FIG. 5 is an illustration of an example device that presents content to users of a shared display in accordance with the techniques presented herein.

FIG. 6 is an illustration of a first example method of presenting content to users of a shared display in accordance with the techniques presented herein.

FIG. 7 is an illustration of a first example method of presenting content to users of a shared display in accordance with the techniques presented herein.

FIG. 8 is an illustration of an example computer-readable storage device that enables a device to present content to users of a shared display in accordance with the techniques presented herein.

FIG. 9 is an illustration of an example scenario featuring an initiation of an individual view for an interacting user on a shared display in accordance with the techniques presented herein.

FIG. 10 is an illustration of an example scenario featuring a management of a group view and an individual view on a shared display in accordance with the techniques presented herein.

FIG. 11 is an illustration of an example scenario featuring a portrayal of perspectives of users in the presentation of content on a shared display in accordance with the techniques presented herein.

FIG. 12 is an illustration of a first example scenario featuring a modification of content by users of a shared display in accordance with the techniques presented herein.

FIG. 13 is an illustration of a second example scenario featuring a modification of content by users of a shared display in accordance with the techniques presented herein.

FIG. 14 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

In various fields of computing, a group of users may engage in a shared experience of viewing and interacting with content that is presented on a display of a device. Some examples of such shared interaction include reviewing a document; examining an image such as a map; and viewing a three-dimensional model or environment. Such scenarios include a variety of techniques for enabling the group of users to view, interact with, manipulate, and in some instances create the content. These scenarios may particularly involve a very-large-scale display, such as a projector coupled with a projector screen, a home theater LCD, or a smart whiteboard. The various techniques may be well-suited for some particular circumstances and may exhibit some technical advantages, but may also be poorly suited for other circumstances and may exhibit some technical disadvantages. As an introduction to the present disclosure, the following remarks illustrate some available techniques.

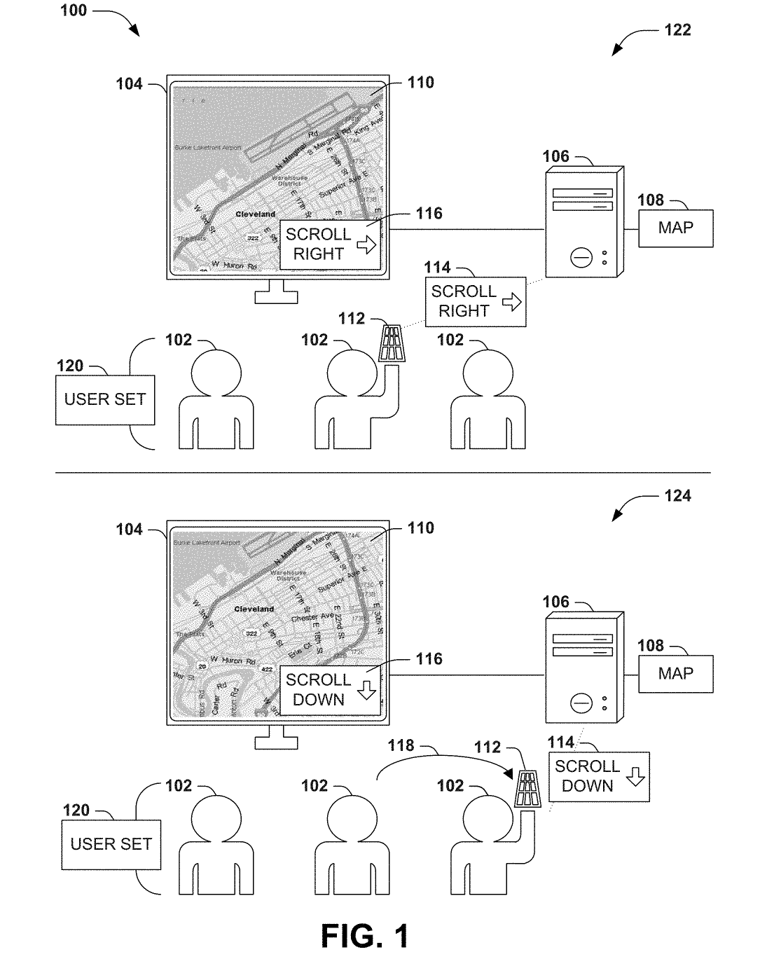

FIG. 1 is an illustration of an example scenario 100 featuring a first example of a group interaction with content. In this example scenario 100, the content comprises a map 108 that is presented on a display 104 of a device 106 to a user set 120 of users 102. The device 106 may store a data representation of the map 108, and may generate a presentation 110 of the map 108 from a particular perspective, such as (e.g.) a location that identifies a center of the map 108 within the presentation 110; a zoom level; and an orientation, such as the rotation of the map about the perspective axis. Other properties may also be altered, such as a map type (e.g., street map, satellite map, and/or topological map); a detail level; and/or a viewing angle that may vary between a top-down or bird's-eye view, a street-level view that resembles the view of an individual at ground level, and an oblique view.

In this example scenario 100, at a first time 122, a first user 102 may alter the perspective of the presentation 110 of the content by manipulating a remote 112. For example, the first user 102 may press buttons that initiate various changes in location and zoom level, such as a scroll command 114 to view a different portion of the map 108. The device 106 may respond by altering the presentation 110 of the map 108, such as applying a perspective transformation 116 that moves the presentation 110 in the requested direction. In this manner, the presentation 110 responds to the commands 114 of the first user 102 while the other users 102 of the user set 120 passively view the presentation 110. At a second time 124, a second user 102 may wish to interact with the presentation 110, such as applying a different scroll command 114 to move the presentation 110 in a different direction. Accordingly, the first user 102 may transfer 118 the remote 112 to the second user 102, who may interact with the presentation 110 and cause the device 106 to apply different perspective transformations 116 by manipulating the remote 112. Accordingly, the presentation 110 responds to the commands 114 of the second user 102 while the other users 102 of the user set 120 (including the first user 102) passively view the presentation 110.

However, in the example scenario 100 of FIG. 1, the presentation 110 enables only a single view of the map 108 at any particular time. The device 106 applies the same perspective transformations 116 to the presentation 110 of the map 108 irrespective of which user 102 is manipulating the remote 112. If a first user 102 wishes to view a first portion of the map 108 and a second user 102 wishes to view a second portion of the map 108, the users must take turns and physically transfer 118 the remote 112 back and forth. In addition to presenting a clumsy user experience, this technique may not support some objectives that the user set 120 may endeavor to perform, such as allowing individual users 102 to explore the map 108 individually and concurrently without interfering with the presentation 110 of the map 108 by the rest of the user set 120, and enabling a visual comparison of two or more concurrently displayed locations of the map 108. Rather, this technique is centered around a presentation 110 of the map 108 that comprises a single view, and that receives and applies operations 114 from any user 102 as an indistinguishable member of the user set 120.

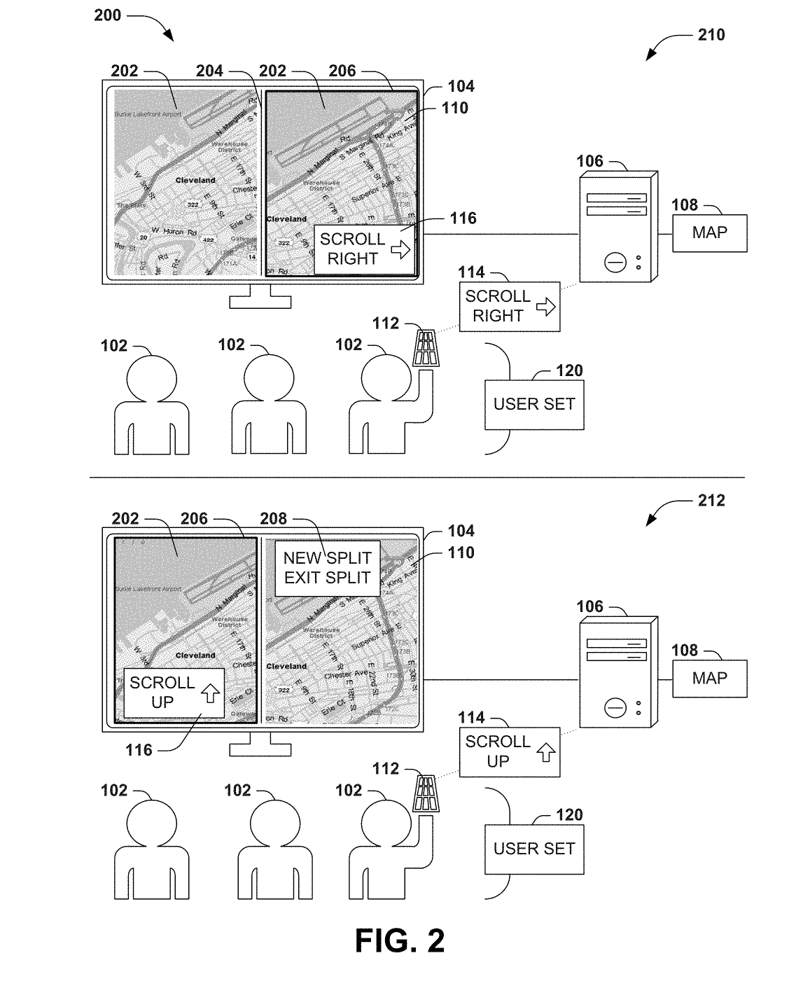

FIG. 2 is an illustration of an example scenario 200 involving a presentation 110 involving multiple views through the use of a “splitter” user interface element. In this example scenario 200, a device 106 presents a map 108 on a display 104 as an arrangement of panes 202 that respectively present an independent view of the map 108, such that commands 114 received from a user set 120 of users 102 (e.g., via a remote 112) cause a perspective transformation 116 of the view presented within one pane 202 without affecting other panes 202 of the presentation 110. The split-view mode may be initiated, e.g., by a “Split View” menu command or button, and may result in an automatic arrangement of panes 202 that are divided by a splitter bar 204.

At a first time 210, a user 102 selects a particular pane 202 as an input focus 206 (e.g., by initiating a click operation within the boundaries of the selected pane 202), and subsequent commands 114 are applied by the device 106 as perspective transformations 116 of the pane 202 that is the current input focus 206 without altering the perspective of the views presented by the other panes 202 of the presentation 110. At a second time 212, the user 102 may initiate perspective transformations 116 of a different view of the map 108 by selecting a different pane 202 as the input focus 206. The device 106 may also provide some additional options for managing panes, such as a context menu 208 that allows users to create a new split in order to insert additional panes 202 for additional views, and the option of closing a particular plane and the view presented thereby.

However, in the example scenario 200 of FIG. 2, the user set 120 may only interact with one pane 202 at a time. Whichever pane 202 has been designated as the input focus 206 receives the commands 114 initiated by the user 102 with the remote 112, while the perspective of the other views presented in the other panes 202 remains static and unaffected. Moreover, this technique also allows only one user 102 of the user set 120 to interact with the map 108 at any particular time, while the other users 102 of the user set 120 remain passive viewers rather than participants. Additionally, the device 106 applies a received command 114 as a perspective transformation 116 of the view 110 serving as the input focus 206 irrespective of which user 102 or device 112 initiated the command 114. In order for two users 102 to interact with different views of the presentation 110, the first user 102 activates a first pane 202 as the input focus 206 and then manipulate it; and then the first user 102 transfers 118 the remote 112 to a second user 102 who activates a second pane 202 as the input focus 206; etc. This user experience involves a consecutive series of piecemeal, interrupted interactions, which may be inefficient and unpleasant for the users 102.

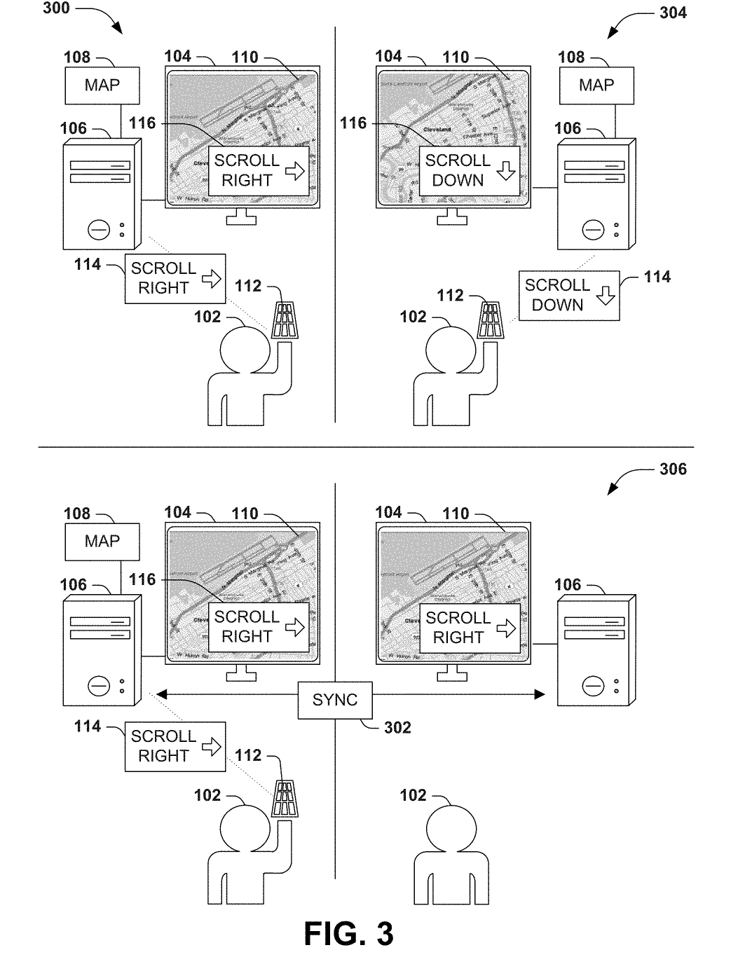

FIG. 3 is an illustration of two example scenarios 300 in which users 102 concurrently interact with content. In a first example scenario 304, a first user 102 interacts with a first device 106 to manipulate a first presentation 110 of the map 108, while a second user 102 interacts with a second device 106 to manipulate a second presentation 110 of the map 108. Both users 102 may utilize the same map 108 (e.g., retrieved from a common source and/or synchronized between the devices 106), and may interact with one view of the presentation 110 without affecting the other view of the presentation 110 on the other device. In a second example scenario 306, the users 102 may share a presentation 110 that is synchronized 302 between the devices 106, such as a screen-sharing technique in which a single presentation 110 is displayed by both devices 106. A first user 102 may interact with the presentation 110 by using commands 114 through a remote 112, and the perspective transition 116 may be applied to the presentation 110 on both the device 106 of the first user 102 and the device 106 of the second user 102. Alternatively (though not shown), the presentation 110 may receive commands 114 from either user 102 and may apply all such commands 114 as perspective transformations 116 of the presentation 110.

However, these techniques exhibit several disadvantages. As first example, the example scenarios 300 of FIG. 3 involve a duplication of hardware, such as a second display 104, a second device 106, and a second remote 112. As a second example, the interaction of each user 102 with a different display 104 and device 106 may reduce the aspect of shared experience, as compared with multiple users 102 cooperatively utilizing a device 106 and display 104. For instance, if the first user 102 and second user 102 are using the first device 106 and first display 104 when the second user 102 chooses to interact with a second view of the presentation 110, the second user 102 has to initiate the presentation 110 on a second set of hardware, as well as establish the shared presentation of the same map 108. These steps may interfere with spontaneous and casual use, as the transition creates a delay or interruption of the shared experience. In many cases, the transition will be unachievable, or at least beyond the capabilities and/or willingness of the users 102, particularly if the second user 102 only wishes to utilize the second view for a brief time. That is, the social characteristic of a gathering of users 102 who are sharing the experience of a presentation by a single device 106 and a single display 104 is more compelling than the social characteristic of the same group of users 102 who are each interacting with a personal device 106 and display. As a third example, the example scenarios 300 present a choice of three alternatives: both users 102 solely interacting with their independent presentations 110 with little attention paid to the other user's view; one user 102 controls the presentation 110 while the other user 102 remains a passive viewer; or the users 102 both provide input to the same presentation 110, which involves the potential for conflicting commands 114 (e.g., requests to scroll in opposite directions) and/or depends upon a careful coordination between the users 102. As a fourth example, these techniques scale very poorly; e.g., sharing the presentation 110 among five users depends upon the interoperation of five devices 106, five displays 104, and potentially even five remotes 112.

As demonstrated in the example scenarios of FIGS. 1-3, many techniques for enabling concurrent multi-user provide only a limited degree of shared experience. Many such techniques also depend upon cooperation among the users 102 (e.g., transfer 118 of a remote 112, or a choice of which user 102 is permitted to manipulate the view in a presentation 110 shared by other users 102) and/or the inclusion of additional hardware. Such techniques may therefore inadequately fulfill the interests of a user set 120 of users 102 who wish to access content in a concurrent yet independent manner on a shared display.

### B. Presented Techniques

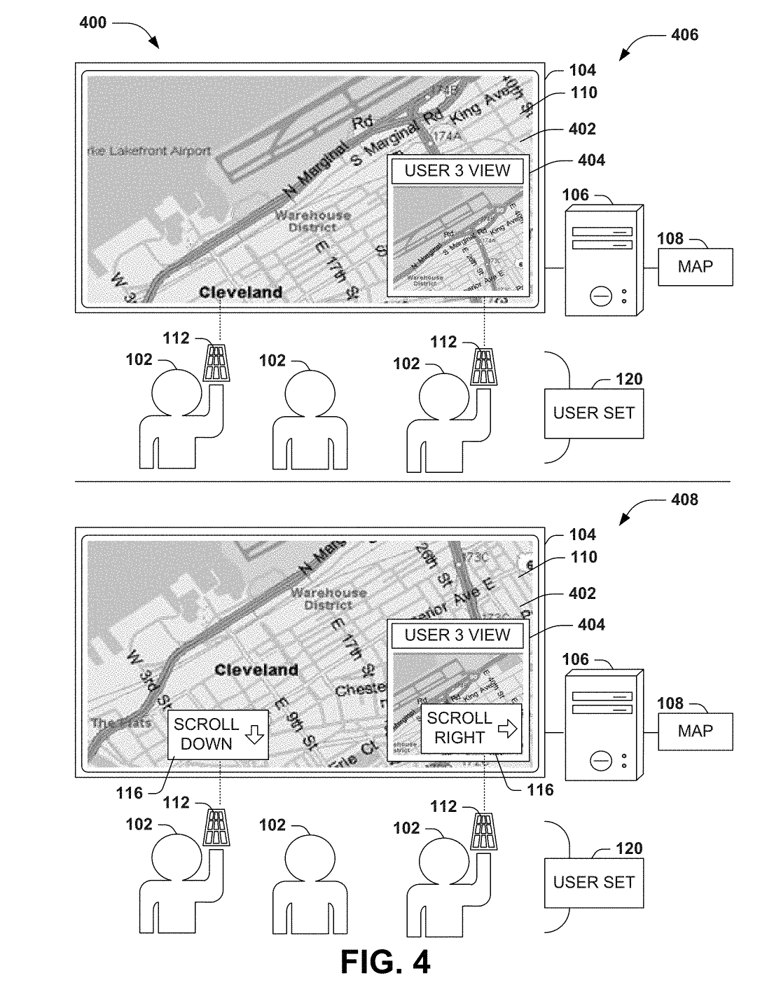

FIG. 4 is an illustration of an example scenario 400 featuring a user set 120 of users 102 who engage in a shared experience involving a presentation 110 of a map 108 on a device 106 in accordance with the techniques presented herein. Such techniques may be particularly advantageous when used with a very-large-scale display, such as a projector coupled with a projector screen or a home theater LCD.

In the example scenario 400 of FIG. 4, a user set 120 of users 102 interact with content in the context of a shared display 104 of a device 106. In this example scenario 400, a map 108 is provided on the display 110 in a presentation 110 of a group view 402 that is controlled by a first user 102 via a remote 112, who may issue a series of commands 114 that result in perspective transformations 116, such as scrolling, changing the zoom level, and rotating the orientation of the map 108 about the perspective axis.

As illustrated in the example scenario 400 of FIG. 4, at a first time 406, a third user 102 of the user set 102 who also bears a remote 112, requests an interaction with the presentation 110. For example, the third user may initiate a scroll request through a remote 112 other than the remote 121 that is controlled by the first user 102. Rather than altering the group view 110 that is manipulated by the first user 102, the device 106 may insert, into the presentation 110, an individual view 404 that is manipulated by the third user 102 (who is designated as an interacting user 102 as a result of the interaction). In this example scenario 400, the individual view 404 is inserted as a subview, inset, or “picture-in-picture” view within the group view 110.

As further illustrated in the example scenario 400 of FIG. 4, at a second time 408, the first user 102 may interact with the group view 402 by initiating commands 114 using a first remote 112, which the device 106 may apply as perspective transformations 116 to the group view 110. Additionally, and in particular concurrently, the interacting user 102 may initiate an interaction with the presentation 110 by initiating commands 114 using a second remote 112, which the device 106 may apply as perspective transformations 116 to the individual view 404, while refraining from applying the commands 114 to the group view 402 that is controlled by the first user 102. For example, the first user 102 uses the first remote 112 to scroll downward in the map 108 while, concurrently, the interacting user 102 uses the second remote 112 to scroll rightward within the map 108. Accordingly, the device 106 may scroll downward (and not rightward) in the group view 402, and may scroll rightward (and not downward) in the individual view 404. In this manner, the device 106 may permit two users 102 of the user set 120 to interact, concurrently but independently, with separate views of the content on a shared display 104 in accordance with the techniques presented herein.

### C. Technical Effects

The use of the techniques presented herein for presenting content to a set of users on a shared display may provide a variety of technical effects.

A first example of a technical effect that may be achieved by the currently presented techniques involves the capability of presenting a plurality of views for the presentation 110 of content. Unlike the techniques shown in the example scenarios 100, 200 of FIGS. 1-2, the association of the respective views with various users 102 of the user set 120 by the currently presented techniques may enable multiple users 102 to interact with content in a manner that is both independent (i.e., perspective transitions are applied to a group view without affecting a second view, and vice versa) and concurrent. This user experience significantly improves upon techniques in which users 102 can only interact with content by transferring 118 a remote 112 between users 102. Additionally, because a first user's interaction with a group view 402 does not affect the individual view 404 of the interacting user 102, the interacting user 102 may pay attention to the actions of the first user 102 without concern of losing his or her place in the content, as established by the perspective of the individual view 404. A converse advantage also applies: because the interacting user's interaction with the individual view 404 does not affect the group view 402 of the first user 102, the first user 102 may pay attention to the actions of the interacting user 102 without concern of losing his or her place in the content, as established by the perspective of the group view 402. In this manner, the inclusion of multiple, concurrent views promotes the shared experience of a user set 120 utilizing a shared display 104.

A second example of a technical effect that may be achieved by the currently presented techniques involves the automatic routing of input to different aspects of the presentation 110, which promotes the capabilities of providing multiple inputs to the device 106 that are routed differently based on user association. In the example scenario 100 of FIG. 1, user input is routed by the device 106 to the presentation 110 generally, without regard to which user 102 initiated the user input through which input device. In the example scenario 100 of FIG. 1, multiple users 102 might concurrently provide user input to the presentation 110—but such user input may conflict (e.g., a first user 102 initiates commands 114 to scroll a map scrolling upward and rightward while a second user 102 concurrently initiates commands 114 to scroll the map downward and leftward). The device 106 responds to such conflict either by completely disregards input from all but one user 102, or by combining the conflicting user input to the presentation 110 with a clumsy and even unusable result. The example scenario 200 of FIG. 2 exhibits similar deficiencies: if multiple users 102 provide user input, the device 106 does not distinguish thereamong, but directs all such input to whichever pane 202 is currently selected as the input focus 206. The users 102 wish to designate panes 202 for respective users 102, but because the device 104 is not configured to support any such allocation, the designation must be applied manually by the users 102. That is, the first user 102 must select the first pane 202 as the input focus 206 before interacting with it; and, consecutively, the second user 102 must select the second pane 202 as the input focus 206 before interacting with it. By contrast, in the currently presented techniques, multiple users 102 may concurrently provide user input to the device 106. Because the presentation 110 provides distinct views that are associated with respective users 102, the device 106 is capable of routing interactions from the first user 102 to the group view 402 and routing interactions from the interacting user 102 to the individual view 404, thereby avoiding user input conflict and alleviating the users 102 of repetitive, manual, and strictly consecutive management, as in the individually designated panes example.

A third example of a technical effect that may be achieved by the currently presented techniques involves the reduction of hardware involved in the shared presentation. The example scenarios 300 of FIG. 3 enable a modest degree of shared experience among the users 102, but also depend upon each user 102 operating a separate device 106, including a separate display 104. In addition to duplicating the hardware utilized by the users 102, this technique reduces the shared experience among the users 102, each of whom interacts primarily with a display 104 and a device 106, as compared with the sharing of a display 104 among the user set 120 as in the example scenario 400 of FIG. 4. Additionally, the currently presented techniques scale well to concurrent use by a larger user set 102; e.g., a single large display may be concurrently utilized by eight users 102 where each interacts with a separate view, while the techniques in the example scenario 300 of FIG. 3 involve eight distinct devices 106 and eight displays 104. An even larger display, such as provided in an auditorium, a classroom, or an interactive exhibit of a museum, may utilize the currently presented techniques to scale to support interaction by a dozen or more users 102—each concurrently interacting with the content in a distinct view in a shared social setting. Many such technical effects may be achieved through the presentation of content to a multitude of users 102 using a shared display 104 in accordance with the techniques presented herein.

### D. Example Embodiments

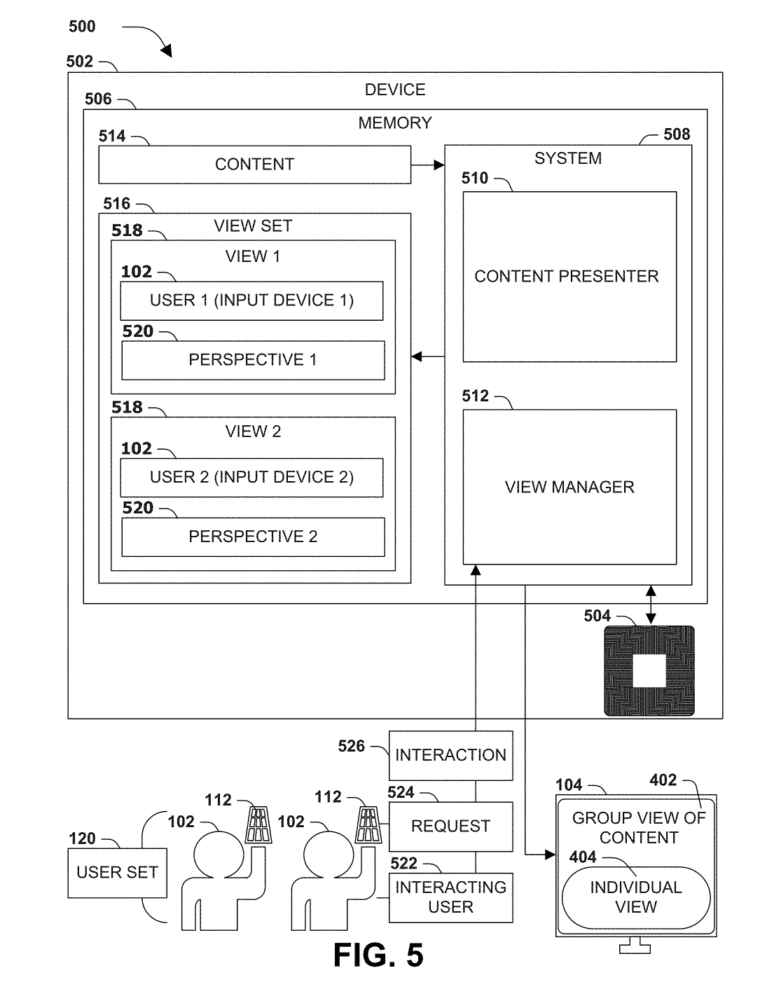

FIG. 5 is an illustration of an example scenario 500 featuring a third example embodiment of the techniques presented herein, illustrated as an example device 502 that provides a system for presenting content to a user set 120 of users 102 in accordance with the techniques presented herein. The example device 502 comprises a memory 506 (e.g., a memory circuit, a platter of a hard disk drive, a solid-state storage device, or a magnetic or optical disc) encoding instructions that are executed by a processor 504 of the example device 502, and therefore cause the device 502 to operate in accordance with the techniques presented herein. In particular, the instructions encode an example system 508 of components that interoperate in accordance with the techniques presented herein. The example system 508 comprises a content presenter 510 that initiates, on a display 104 that is shared by the at least two users 102, a presentation comprising a group view 402 of the content 514. The content presenter 510 also receives a request, from an interacting user 522 selected from the at least two users 102, to alter the group view 402 of the content 514, and inserts into the presentation an individual view 404 of the content 514 for the interacting user 102. The example system 508 also comprises a view manager 512 that receives an interaction from the interacting user 522 that alters the presentation of the content 514, and applies the interaction 526 to the individual view 404 of the content 514 while refraining from applying the interaction to the presentation of the content 514 in the group view 104. In such manner, the example device 502 may utilize a variety of techniques to enable the presentation of the content to the user set 120 of users 102 of a shared display 104 in accordance with the techniques presented herein.

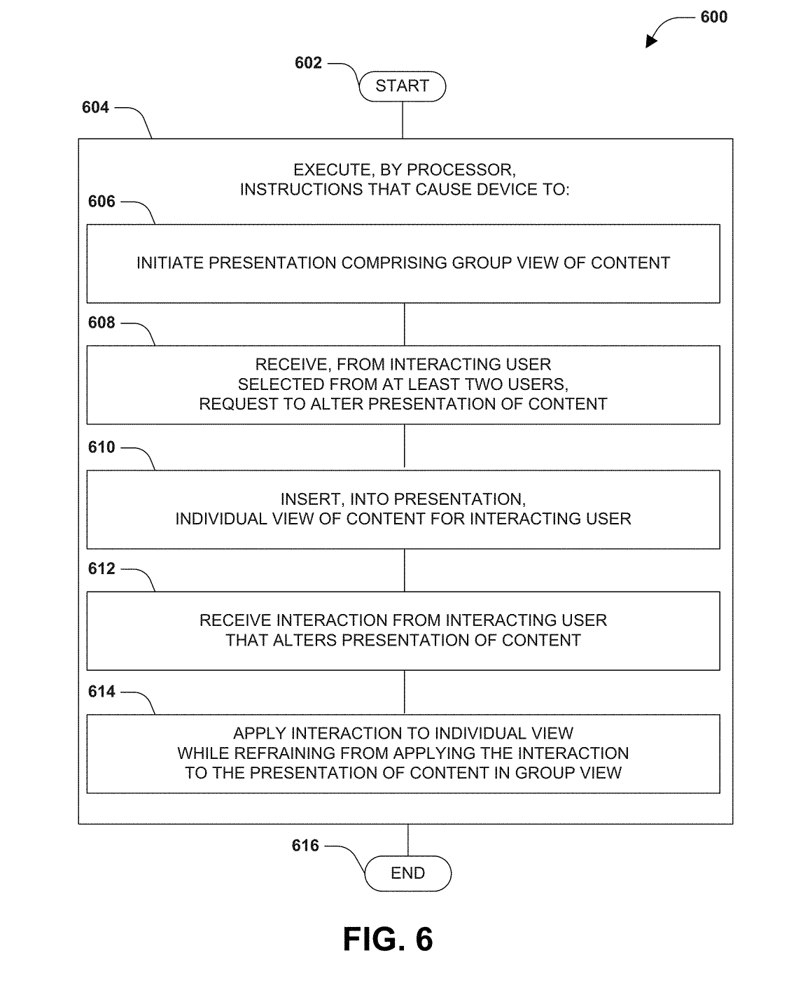

FIG. 6 is an illustration of an example scenario featuring a second example embodiment of the techniques presented herein, wherein the example embodiment comprises a first example method 600 of presenting content to a user set 120 of users 102 in accordance with techniques presented herein. The example method 600 involves a device comprising a processor 504, and may be implemented, e.g., as a set of instructions stored in a memory 506 of the device, such as firmware, system memory, a hard disk drive, a solid-state storage component, or a magnetic or optical medium, wherein the execution of the instructions by the processor 504 causes the device to operate in accordance with the techniques presented herein.

The first example method 600 begins at 602 and involves executing, by the processor 504, instructions that cause the device to operate in accordance with the techniques presented herein. In particular, the execution of the instructions causes the device to initiate 606 a presentation 110 comprising a group view 402 of the content 514. The execution of the instructions also causes the device to receive 608, from an interacting user 102 selected from the at least two users 102, a request 524 to alter the presentation 110 of the content 514. The execution of the instructions also causes the device to insert 610 into the presentation 110 an individual view 404 of the content 514 for the interacting user 522. The execution of the instructions also causes the device to receive 612 an interaction 526 from the interacting user 522 that alters the presentation 110 of the content 514. The execution of the instructions also causes the device to apply 614 the interaction 526 to the individual view 404 of the content 514 while refraining from applying the interaction 526 to the presentation of the content 514 in the group view 402. In this manner, the first example method 600 may enable the device to present content 514 to users 102 of a user set 120 via a shared display 104 in accordance with the techniques presented herein, and so ends at 616.

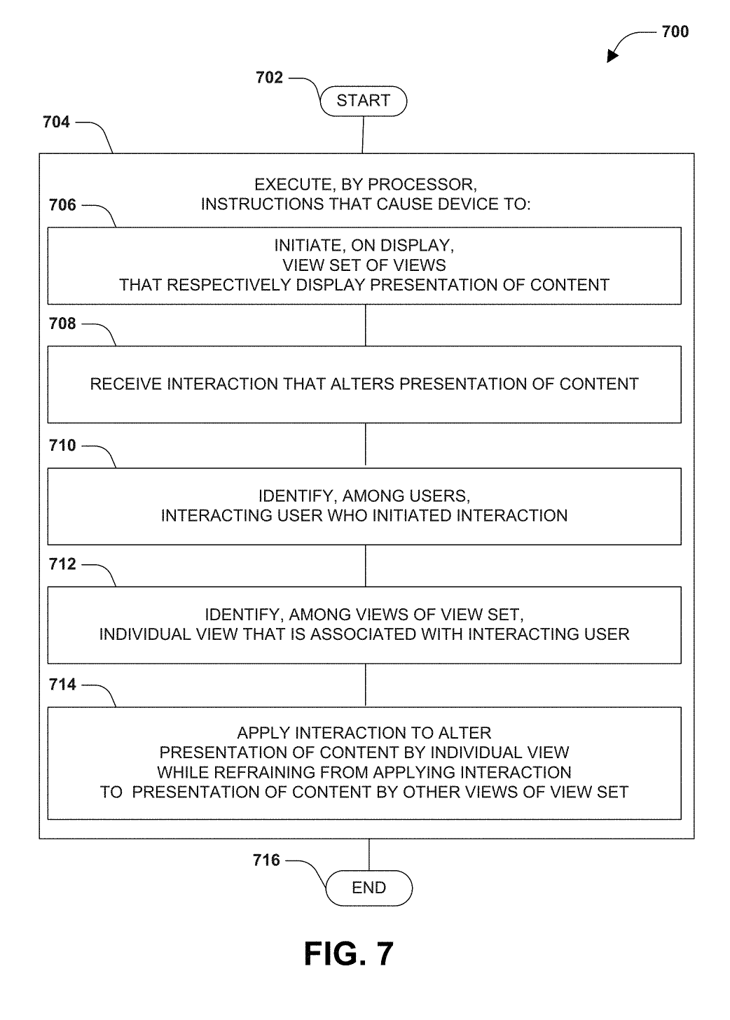

FIG. 7 is an illustration of an example scenario featuring a third example embodiment of the techniques presented herein, wherein the example embodiment comprises a second example method 700 of presenting content to a user set 120 of users 102 in accordance with techniques presented herein. The example method 700 involves a device comprising a processor 504, and may be implemented, e.g., as a set of instructions stored in a memory 506 of the device, such as firmware, system memory, a hard disk drive, a solid-state storage component, or a magnetic or optical medium, wherein the execution of the instructions by the processor 504 causes the device to operate in accordance with the techniques presented herein.

The second example method 700 begins at 702 and involves executing, by the processor 704, instructions that cause the device to operate in accordance with the techniques presented herein. In particular, the execution of the instructions causes the example device 502 to initiate 706, on a display 106, a view set 516 of views 518 that respectively display a presentation 110 of the content 514. The execution of the instructions also causes the example device 502 to receive 708 an interaction 526 that alters the presentation 110 of the content 514. The execution of the instructions also causes the example device 502 to identify 710, among the users 102 of the user set 120, an interacting user 522 who initiated the interaction 526. The execution of the instructions also causes the example device 502 to identify 712, among the views 518 of the view set 516, an individual view 404 that is associated with the interacting user 522. The execution of the instructions also causes the example device 502 to apply 714 the interaction 526 to alter the presentation 110 of the content 514 by the individual view 404 while refraining from applying the interaction 526 to the presentation 110 of the content 514 by other views 518 of the view set 516. In this manner, the second example method 700 may enable the example device 502 to present the content 514 to the users 102 of the user set 120 via a shared display in accordance with the techniques presented herein, and so ends at 716.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

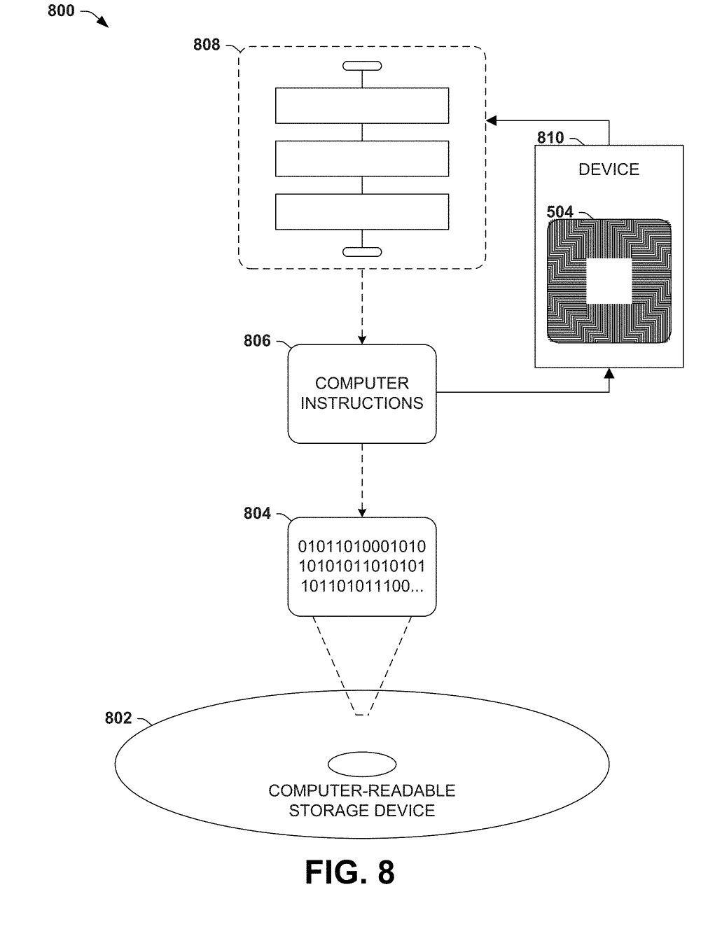

An example computer-readable medium that may be devised in these ways is illustrated in FIG. 8, wherein the implementation 800 comprises a computer-readable memory device 802 (e.g., a CD-R, DVD-R, or a platter of a hard disk drive), on which is encoded computer-readable data 804. This computer-readable data 804 in turn comprises a set of computer instructions 806 that, when executed on a processor 504 of a device 810, cause the device 810 to operate according to the principles set forth herein. For example, the processor-executable instructions 806 may encode a system that presents content 514 to users 102 via a shared display 104, such as the example system 508 of the example device 502 of FIG. 5. As another example, the processor-executable instructions 806 may encode a method of presenting content 514 to users 102 via a shared display 104, such as the first example method 600 of FIG. 6 and/or the second example method 700 of FIG. 7. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the first example method of FIG. 4; the second example method of FIG. 5; and the example device 602 and/or example method 608 of FIG. 6) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized on a variety of devices, such as servers, workstations, laptops, consoles, tablets, phones, portable media and/or game players, embedded systems, appliances, vehicles, and wearable devices. Such devices may also include collections of devices, such as a distributed server farm that provides a plurality of servers, possibly in geographically distributed regions, that interoperate to present content 514 to users 102 of a shared display 104.

As a second variation of this first aspect, the content 514 may be presented on many kinds of shared displays 104, such as an LCD of a tablet, workstation, television, or large-scale presentation device, or a projector that projects the content 514 on a projector screen or surface. In some circumstances, the display 104 may comprise an aggregation of multiple display components, such as an array of LCDs that are positioned together to create an appearance of a larger display, or a set of projectors that project various portions of a computing environment on various portions of a large surface. In some embodiments, the display 104 may be directly connected with the device, including direct integration with the device such as a tablet or an “all-in-one” computer. In other embodiments, the display 104 may be remote from the device, such as a projector that is accessed by the device via a Wireless Display (WiDi) protocol, or a server (including a server collection) that transmits video to a display 104 over the internet. Many such architectural variations may be utilized by embodiments of the techniques presented herein.

As a third variation of this first aspect, the users 102 may initiate interactions 526 with the presentation 110 in numerous ways. As a first such example, the users 102 may utilize a handheld device such as a remote 112 (e.g., a traditional mouse or touchpad, a gyroscopic “air mouse,” a pointer, or a handheld controller such as for a game console or virtual-reality interface). As a second such example, the users 102 may interact via touch with a touch-sensitive display 104, via technology such as capacitive touch that is sensitive to finger and/or stylus input. A variety of touch-sensitive displays may be used that are adapted for manual and/or device-based touch input. As a third such example, the users 102 may interact via gestures, such as manually pointing and/or gesturing at the display 104. Such gestures may be detected, e.g., via a camera that captures images for evaluation by anatomic and/or movement analysis techniques, such as kinematic analysis. As a fourth such example, the users 102 may verbally interact with the device, such as issuing verbal commands that are interpreted by speech analysis.

As a fourth variation of this first aspect, the shared display 104 may be used to present a variety of content 514 to the users 102, such as text (e.g., a document), images (e.g., a map), sound, video, two- and three-dimensional models and environments. The content 514 may comprise a collection of content items, such as an image gallery, a web page, or a social networking or social media presentation. The content 514 may support many forms of interaction 526 that alters the perspective of a view 518, such as scrolling, panning, zooming, rotational orientation, and/or field of view. The device may also enable forms of interaction 526 that alter the view 518 in other ways, such as toggling a map among a street depiction, a satellite image, a topographical map, and a street-level view, or toggling a three-dimensional object between a fully rendered version and a wireframe model. The interaction 526 may also comprise various forms of navigation within the content 514, such as browsing, indexing, searching, and querying. Some forms of content 514 may be interactive, such as content 514 that includes user interface elements that alter the perspective of the view 518, such as buttons or hyperlinks. In some circumstances, the interaction 526 may not alter the content 514 but merely the presentation 110 in one or more views 518. In other circumstances, the interaction 526 may alter the content 514 for one or more views 518. Many such scenarios may be devised in which content 514 is presented to a user set 120 of users 102 of a shared display 104 in which a variation of the currently presented techniques may be utilized.

E2. Initiating Individual Views

A second aspect that may vary among embodiments of the presented techniques involves the initiation of an individual view 404 within the presentation 110 of the content 514.

As a first variation of this second aspect, the request 524 to initiate the individual view 404 by the interacting user 522 may occur in several ways. As a first such example, the request 524 may comprise a direct request by the interacting user 522 or another user 102 of the user set 120 to create an individual view 404 for the interacting user 522, such as a selection from a menu or a verbal command. As a second such example, the request 524 may comprise an interaction 526 by the interacting user 522 with the presentation 110, such as a command 114 to pan, zoom, change orientation, etc. of the perspective of the presentation 110. The device may detect that the interaction 526 is from a different user 102 of the user set 120 than the first user 102 who is manipulating the group view 104. As a third such example, the request 524 may comprise user input to the device from an input device that is not owned and/or utilized by a user 102 who is associated with the group view 104 (e.g., a new input device that is not yet associated with any user 102 to whom at least one view 518 of the view set 516 is associated). As a fourth such example, the request 524 may comprise a gesture by a user 102 that the device may interpret as a request 524 to initiate an individual view 404, such as tapping on or pointing to a portion of the display 104. Any such interaction 526 may be identified as a request 524 from a user 102 to be designated as an interacting user 522 and associated with an individual view 404 to be inserted into the view set 516. As an alternative to these examples, in some scenarios, the group view 104 may not be controlled by any user 102 of the user set 120, but may be an autonomous content presentation, such that any interaction 526 by any user 102 of the user set 120 results in the insertion of an individual view 404.

As a second variation of this second aspect, the individual view 404 may be selected in many ways. As a first such example, the location of the individual view 404 may be selected in various ways, including with respect to the other views 518 of the view set 516. For example, the device 404 may automatically arrange the views 518 of the view set 516 to share the display 104, such as a tile arrangement. Alternatively, the device may maintain a set of boundaries of the group view 402 of the content 514, and insert the individual view 404 as an inset view within the set of boundaries of the group view 402, e.g., as a picture-in-picture presentation. As a second such example, the interacting user 522 may specify the location, shape, and/or dimensions of the individual view 404, e.g., by drawing a rectangle to be used as the region for the individual view 404. As a third such example, the location, shape, and/or dimensions may be selected by choose a view size according to the focus on the selected portion of the content 514. For example, an interacting user 522 may select an element of the content 514 for at least initial display by the individual view 404 (e.g., a portion of the content 514 that the interacting user 522 wishes to inspect in greater detail). Alternatively or additionally, the location, shape, and/or dimensions of the individual view 404 may be selected to avoid overlapping portions of the content with which other users 102, including the first user 102, are interacting. For example, if the content 514 comprises a map, the location, shape, and/or dimensions of an individual view 404 inserted into the view set 516 may be selected to position the individual view 404 over a relatively barren portion of the map, and to avoid overlapping areas of more significant detail. As a fourth such example, an interaction request 524 from the interacting user 522 may comprise a selection of a display location on the display 104 (e.g., the user may tap, click, or point to a specific location on the display 104 where the individual view 404 is to be inserted), and the device may create the individual view 404 at the selected display location on the display 104. As a fifth such example, a device may initiate and/or maintain an individual view 404 in relation to a physical location of the interacting user 522, chooses a display location on the display 104 that is physically proximate to the physical location of the interacting user 522, and presents the individual view 404 at the display location. Alternatively or additionally, the device may detect a change of a physical location of the interacting user 522 to a current physical location, and may respond by choosing an updated display location on the display 106 that is physically proximate to the current physical location of the interacting user 522 and reposition the individual view 404 at the updated display location.

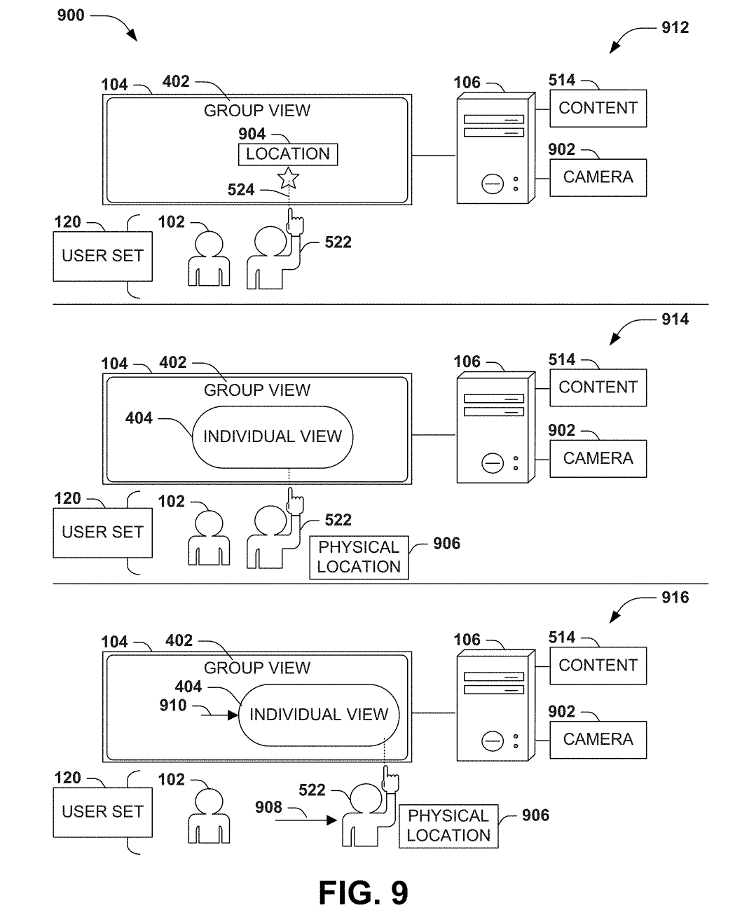

FIG. 9 is an illustration of an example scenario 900 featuring some techniques for initiating the individual view 404 of content 514 on a shared display 104. In this example scenario, at a first time 912, an interacting user 522 of the user set 120 initiates an interaction 524 that involves pointing at a particular location 904 on the display 104 within a group view 402 of some content 514. Using a camera 902, the device 106 monitors the actions of the users 102 and detects the pointing gesture, which it interprets as a request 524 to create an individual view 404. Moreover, the device 106 detects the display location 904 where the user 102 is pointing, such that, at a second time 914, the device 106 may present the individual view 404 at the display location 904 to which the interacting user 522 pointed. In this example scenario 900, the individual view 404 is presented as a curved shape such as a bubble, and as an inset within the group view 104 of the content 514 with which the first user 102 is interacting. Additionally, at the second time 914, the device 106 may use the camera 902 to detect a physical location 906 of the interacting user 522 relative to the display 104, such that when the interacting user 522 moves 908 to a different physical location 906 at a third time 916, the device 106 may respond to the change of position by relocating 910 the individual view 404 to an updated display location 904 that is closer to the new physical location 906 of the interacting user 522. Such relocating 910 may be advantageous, e.g., for improving the accuracy and/or convenience of the interaction between the interacting user 522 and the display 104. Many such techniques may be utilized to initiate the individual view 404 in the presentation of content 514 on a shared display 104 in accordance with the techniques presented herein.

E3. Managing Concurrent Views

A third aspect that may vary among embodiments of the presented techniques involves managing the views 518 of the view set 516 that are concurrently presented on a shared display 104.

As a first variation of this third aspect, after initiating the group view 402 and the individual view 404, a device may be prompted to adjust the location, shape, dimensions, or other properties of one or more of the views 518. As a first such example, a user 102 may perform an action that specifically requests changing a particular view 516, such as performing a maximize, minimize, resize, relocate, or hide gesture. As a second such example, as the presentation 110 of the content 514 within one or more of the views 518 changes, a device may relocate one or more of the views 516. For example, if a user 102 interacting with a particular view 518 zooms in on a particular portion of the content 514, it may be desirable to expand the dimensions of the view 518 to accommodate the zoomed-in portion while continuing to show the surrounding portions of the content 514 as context. Such expansion may involve reducing and/or repositioning adjacent views 518 to accommodate the expanded view 518. As a third such example, if a user 102 interacting with a particular view 518 zooms out beyond the boundaries of the content 514, the boundaries of the view 518 may be reduced to avoid the presentation of blank space around the content 514 within the view 518, which may be unhelpful.

As a second variation of this third aspect, respective users 102 who are interacting with a view 518 of the display 104 may do so with an interaction dynamic degree. For example, a first user 102 who is interacting with a group view 518 may be comparatively active, such as frequently and actively panning, zooming, and selecting content 514, while a second user 102 who is interacting with a second view 518 may be comparatively passive, such as sending commands 114 only infrequently and predominantly remaining idle. A device may choose a view size for the respective views 518 according to the interaction dynamic degree of the interaction of the associated user 102 with the view 518, such as expanding the size of the group view 518 for the active user 102 and reducing the size of the second view 518 for the passive user 102.

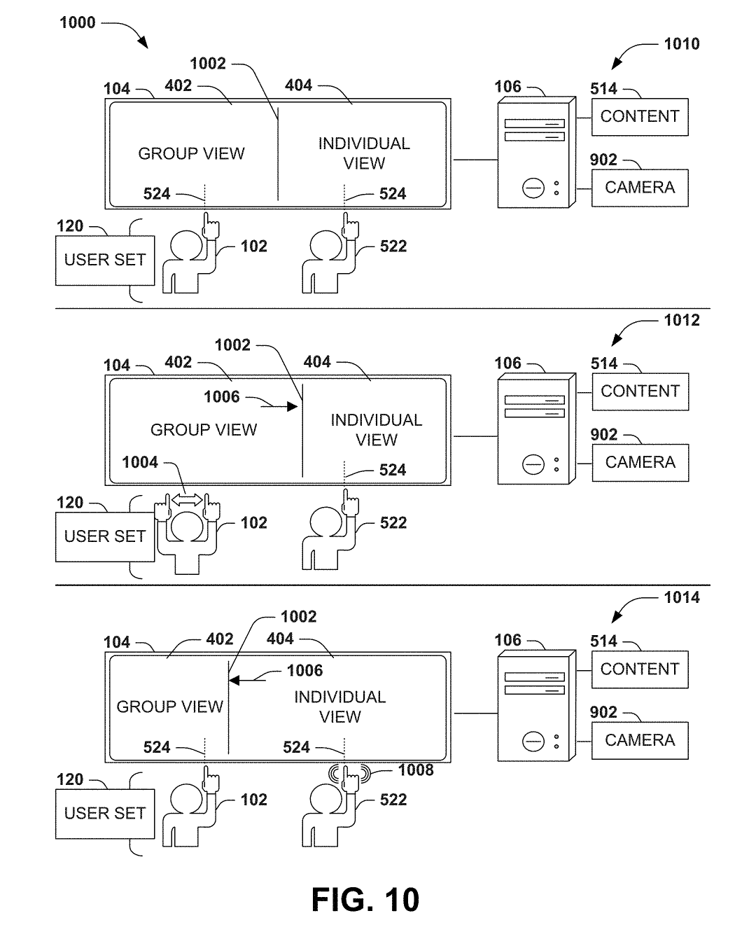

FIG. 10 is an illustration of an example scenario 1000 featuring several such variations for maintaining the presentation of a set of views 518. In this example scenario 1000, at a first time 1010, a device 106 presents content 514 to a user set 120 of users 102, including a first user 102 engaging in an interaction 524 with a group view 402 and a second user 522 engaging in an interaction 524 with an individual view 404. At this first time 1010, the group view 402 and the individual view 404 are presented side-by-side with a visible partition 1002, and the users 102 engage in interaction 524 via manual gestures, e.g., without the use of a handheld remote 112 or other input device, and the device 106 uses a camera 902 to detect the gestures and interpret the interaction 524 indicated thereby. In particular, at a second time 1012, the first user 102 may perform a manual gesture 1004 that requests an expansion of the group view 402, and the device 106 may respond by moving 1006 the visible partition 1002 to expand the group view 402 and reduce the individual view 404. Such expansion many include, e.g., the inclusion of additional content in the group view 402 that was not visible in the previously presented smaller view. At a third time 1014, the interacting user 524 may engage in interaction 524 with a high interaction dynamic degree 1008, such as gesticulating rapidly, and the device 106 may respond by moving 1006 the visible partition 1002 to expand the individual view 404 and reduce the group view 402. In this manner, the device 106 may actively manage the sizes of the views 518 of the view set 516 in accordance with the techniques presented herein.

As a third variation of this third aspect, a device 106 may use a variety of techniques to match interactions 526 with one or more of the concurrently displayed views 518 that are concurrently displayed as a view set 516—i.e., the manner in which the device determines the particular view 518 of the view set 516 to which a received interaction 526 is to be applied. As a first such example, the device may further comprise an input device set of input devices that are respectively associated with a user 102 of the user set 102. For example, the first user 102 may be associated with a first input device (such as a remote 112), and a second, interacting user 522 may utilize a second input device. Identifying an interacting user 522 may further comprise identifying, among the input devices of the input device set, an interacting input device that received user input comprising the interaction 526, and identifying, among the users 102 of the user set 120, the interacting user 522 that is associated with the interacting input device. Such techniques may also be utilized as the initial request 524 to interact with the content 514 that prompts the initiation of the individual view 404; e.g., a device 106 may receive an interaction 526 from an unrecognized device that is not currently associated with the first user 102 or any current interacting user 522, and may initiate a new individual view 404 for the user 102 of the user set 120 that is utilizing the unrecognized input device. As a second such example, a device may detect that an interaction 526 occurs within a region within which a particular view 518 is presented; e.g., a user 102 may touch or draw within the boundaries of a particular view 518 to initiate interaction 526 therewith. As a third such example, a device may observe actions by the users 102 of the user set 120 (e.g., using a camera 902), and may identify the interacting user 522 by identifying, among the actions observed by the device, a selected action that initiated the request 524 or the interaction 526, and identifying, among the users 102 of the user set 120, the interacting user 522 that performed the action that initiated the request 524 or interaction 526. Such techniques may include, e.g., the use of biometrics such as face recognition and kinematic analysis to detect an instance of a gesture and/or the identity of the user 102 performing the gesture. In devices that permit touch interaction, the identification of an interacting user 522 may be achieved via fingerprint analysis.

As a fourth variation of this third aspect, a device 106 may strictly enforce the association of interactions 526 by respective users 102 and the views 518 of the view set 516 to which such interaction 526 are applied. Alternatively, in some circumstances, a device 106 may permit an interaction 526 by one user 102 to affect a view 518 that is associated with another user 102 of the user set 120. As a first such example, the device may receive, from an overriding user 102 of the users 102 of the user set 120, an overriding request to interact with an overridden view 518 that is not associated with the overriding user 102. The device may fulfill the overriding request by applying interactions 526 from the overriding user to the presentation 110 of the content 514 within the overridden view. As a second such example, an interaction 526 by a particular user 102 may be applied synchronously to multiple views 518, such as focusing on a particular element of the content 514 by navigating the perspective of each view 518 to a shared perspective of the element. As a third such example, a device may reflect some aspects of one view 518 in other views 518 of the view set 516, even if such views 516 remain independently controlled by respective users 102. For example, where respective views 518 of the view set 516 present a perspective within the content 110 (e.g., a vantage point within a two- or three-dimensional environment), the presentation 110 may include a map that illustrates the perspectives of the views 518 of the view set 516. A map of this nature may assist users 102 in understanding the perspectives of the other users 102; e.g., while one user 102 who navigates to a particular vantage point within an environment may be aware of the location of the vantage point within the content 514, a second user 102 who looks at the view 518 without this background knowledge may have difficulty determining the location, particularly in relation to the vantage point of the second user's view 518. A map depicting the perspectives of the users 102 may enable the users 102 to coordinate their concurrent exploration of the shared presentation 110.

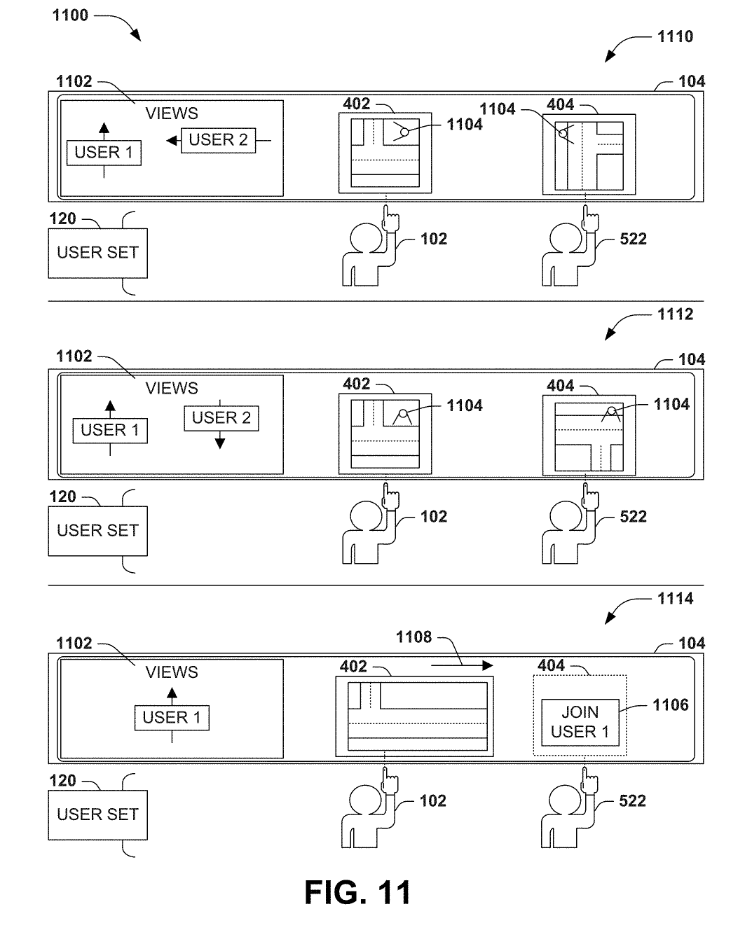

FIG. 11 is an illustration of an example scenario 1100 featuring one such example for facilitating users 102 of a shared display 104. In this example scenario 1100, a first user 102 interacts with a group view 402 of content 514, and an interacting user 522 interacts with an individual view 404 of the content 514, where each such interaction 526 exhibits a perspective within a two-dimensional map. The presentation 110 also includes two graphical indications of the perspectives of the users 102. First, a perspective map 1102 indicates the relative locations and orientations of the perspectives of the users 102. Second, the respective views 402 for each user 102 includes a graphical indicator 1104 of the perspective of the other user 102 within the content 514 as viewed from the perspective of the user 102 interacting with the view 518. At a first time, the users 102 may have various perspectives; and at a second time 1112, a change of perspective of the interacting user 522 (such as a ninety-degree clockwise rotation of the content 110) may be depicted not only by updating the individual view 404 to reflect the updated perspective of the content 514, but also by changing both the perspective map 1102 and the graphical indicator 1104 in the group view 402. Additionally, at a third time 1114, the interacting user 522 may move the perspective of the individual view 404 to match the perspective of the group view 402 utilized by the first user 102. This action may be interpreted as a request to join 1106 the individual view 404 with the group view 402, and the device may therefore terminate the individual view 404. Such termination may occur even if the perspectives are not precisely aligned, but are “close enough” to present a similar perspective of the content 514 in both views 518. In doing so, the device may remove the perspective of the interacting user 522 from the map 1102, and may also expand 1108 the group view 402 to utilize the space on the display 104 that was formerly allocated to the individual view 404. In this manner, the device may manage and coordinate the perspectives of the views 518 of the respective users 102. Many such variations may be included in the management of the views 518 of the view set 516 in accordance with the techniques presented herein.

E4. Managing Content Modifications

A fourth aspect that may vary among embodiments of the techniques presented herein involves the managing modifications to the content 514 by the users 102 of the respective views 518. In many scenarios involving the currently presented techniques, the content 514 may be unmodifiable by the users 102, such as a static or autonomous two- or three-dimensional environment in which the users 102 are only permitted to view the content 514 from various perspectives. However, in other such scenarios, the content 514 may be modifiable, such as a collaborative document editing session; a collaborative map annotation; a collaborative two-dimensional drawing experience; and/or a collaborative three-dimensional modeling experience. In such scenarios, content modifications that are achieved by one user 102 through one view 518 of the view set 516 may be applicable in various ways to the other views 518 of the view set 516 that are utilized by other users 102.

As a first variation of this fourth aspect, a modification of the content 514 achieved through one of the views 518 by one of the users 102 of the user set 120 may be propagated to the views 518 of other users 102 of the user set 120. For example, a device may receive, from an interacting user 522, a modification of the content 514, and may present the modification in the group view 402 of the content 514 for the first user 102. Conversely, a device may receive, from the first user 102, a modification of the content 514, and may present the modification in the individual view 404 of the content 514 for the interacting user 522.

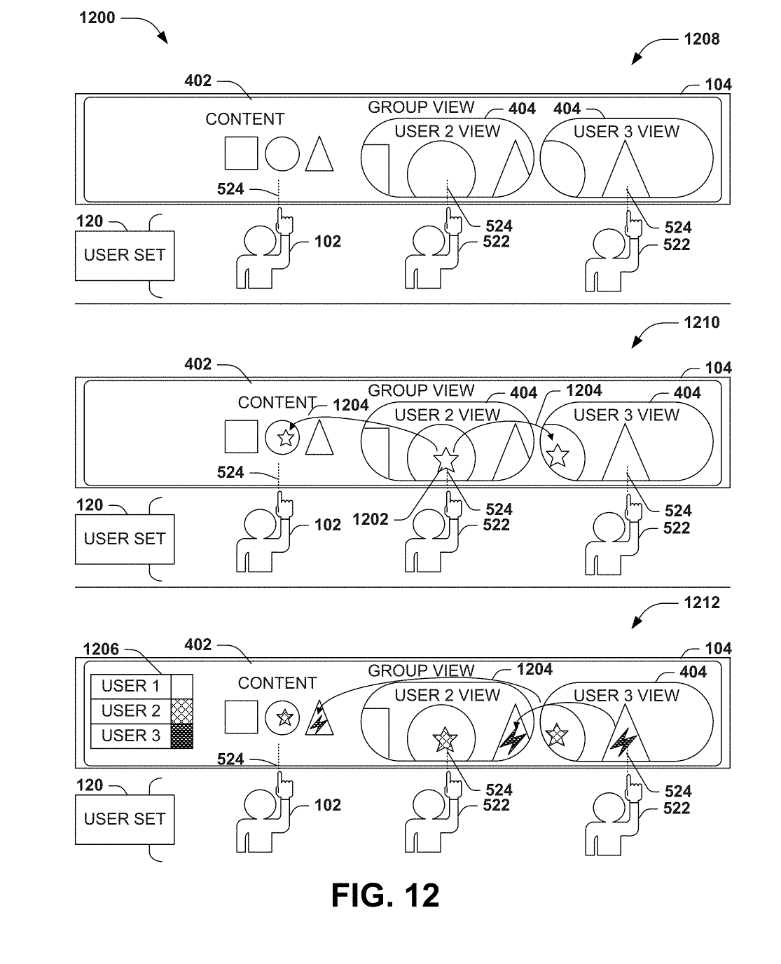

FIG. 12 is an illustration of an example scenario 1200 in which modifications of content 514 are propagated among the views 518 of a view set 516 on a shared display 104. In this example scenario 1200, at a first time 1208, a first user 102 is initiating an interaction 524 with content 514 in a group view 402, while a first interacting user 522 and a second interacting user 522 respectively initiate interactions 524 with the content 514 respectively through a first individual view 404 and a second individual view 404. The same content 514 is presented in all three views, but each user 102 is permitted to change the perspective of the view 518 with which the user 102 is associated. At a second time 1210, the first interacting user 522 applies a first modification 1202 to the content 514, e.g., the addition of a symbol. A device may promptly propagate 1204 the first modification 1202 to the group view 404 of the first user 102 and the second individual view 404 of the second interacting user 522 to maintain synchrony among the views 518 of the content 514 as so modified. At a third time 1212, the second interacting user 522 applies a second modification 1202 to the content 514, e.g., the addition of another symbol. The device may additionally promptly propagate 1204 the second modification 1202 to the group view 402 of the first user 102 and the first individual view 404 first interacting user 522 to maintain synchrony among the views 518 of the content 514 as so modified.

Additionally, the device may apply a distinctive visual indicator to the respective modifications 1202 (e.g., shading, highlighting or color-coding) to indicate which user 102 of the user set 120 is responsible for the modification 1202. Moreover, the device may insert into the presentation a key 1206 that indicates the users 102 to which the respective visual indicators are assigned, such that a user 102 may determine which user 102 of the user set 120 is responsible for a particular modification by cross-referencing the visual indicator of the modification 1202 with the key 1206. In this manner, the device may provide a synchronized interactive content creation experience using a shared display 104 in accordance with the techniques presented herein.

As a second variation of this fourth aspect, various users 102 may be permitted to modify the content 514 on the shared display 104 in a manner that is not promptly propagated into the views 518 of the other users 102 of the user set 120. Rather, the content 514 may be permitted to diverge, such that the content 514 bifurcates into versions (e.g., an unmodified version and a modified version that incorporates the modification 1202). If the modification 1202 is applied to the individual view 404, the device may present an unmodified version of the content 514 in the group view 402 and a modified version of the content 514 in the individual view 404. Conversely, if the modification 1202 is applied to the group view 402, the device may present an unmodified version of the content 514 in the individual view 404 and a modified version of the content 514 in the group view 402. A variety of further techniques may be applied to enable the users 102 of the user set 120 to present any such version within a view 518 of the view set 516, and/or to manage the modifications 1202 presented by various users 102, such as merging the modifications 1202 into a further modified version of the content 514.

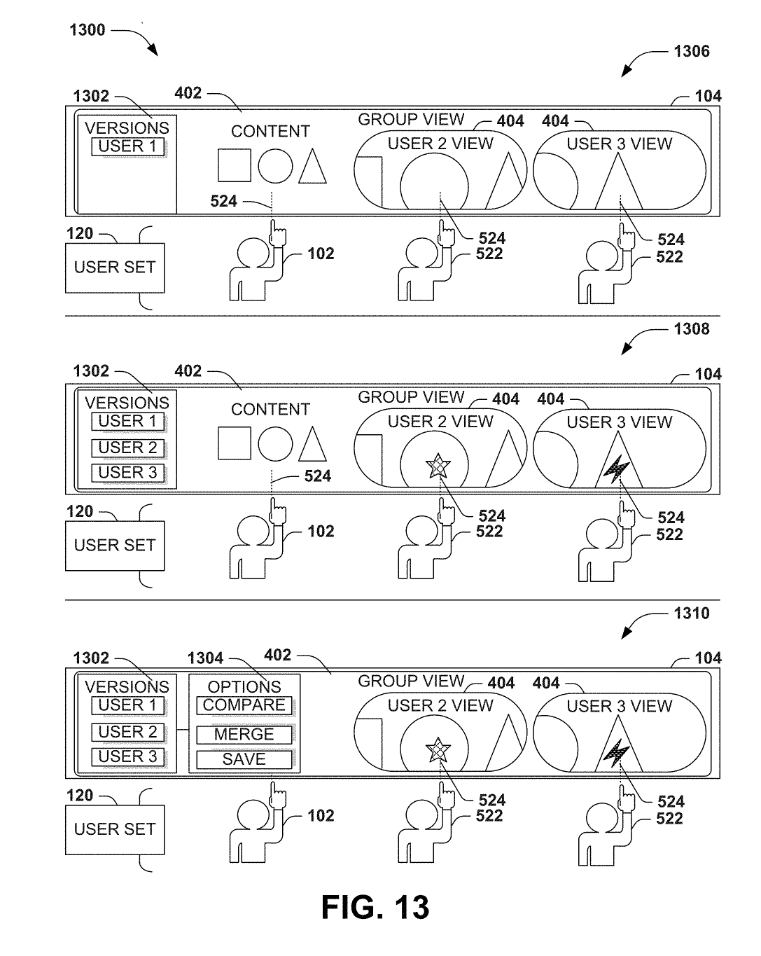

FIG. 13 is an illustration of an example scenario 1300 in which modifications 1202 by various users 102 of a shared display 104 result in a bifurcation of the content 514 into multiple versions. In this example scenario 1300, at a first time 1306, a first user 102 is initiating an interaction 524 with content 514 in a group view 402, while a first interacting user 522 and a second interacting user 522 respectively initiate interactions 524 with the content 514 respectively through a first individual view 404 and a second individual view 404. The presentation may include a version list 1302 that indicates the versions of the content 514 (e.g., indicating that only one version is currently presented within the views 518 of all users 102). At a second time 1308, the first interacting user 522 and the second interacting user 522 may each introduce a modification 1202 to the unmodified version of the content 514. Instead of promptly propagating 1204 the modifications 1202 into the other views 518, a device may permit each view 518 in which a modification 1202 has occurred to display a new version of the content 514 that incorporates the modification 1202. The version list 1302 may be updated to indicate the versions of the content 514 that are currently being presented. At a third time 1310, the first user 102 may endeavor to manage the versions of the content 514 in various ways, and the presentation 110 may include a set of options 1304 for evaluating the versions, such as comparing the versions (e.g., presenting a combined presentation with color-coding applied to the modifications 1202 of each user 102); merging two or more versions of the content 514; and saving one or more versions of the content 514. In this manner, the device may provide content versioning support for an interactive content creation experience using a shared display 104 in accordance with the techniques presented herein.

As a third variation of this fourth aspect, many types of modifications 1202 may be applied to the content 514, such as inserting, modifying, duplicating, or deleting objects or annotations, and altering various properties of the content 514 or the presentation 110 thereof (e.g., transforming a color image to a greyscale image). As one such example, the presentation 110 of the content 514 may initially be confined by a content boundary, such as an enclosing boundary placed around the dimensions of a map, image, or two- or three-dimensional environment. Responsive to an expanding request by a user 102 to view a peripheral portion of the content 514 that is beyond the content boundary, a device may expand the content boundary to encompass the peripheral portion of the content 514. For example, when a user 102 issues a command 114 to scroll beyond the edge of an image in a drawing environment, the device may expand the dimensions of the image to insert blank space for additional drawing. Similarly, when a user 102 scrolls beyond the end of a document, the device may expand the document with additional space to enter more text, images, or other content. Many techniques may be utilized to manage the modification 1202 of content 514 by the users 102 of a shared display 104 in accordance with the techniques presented herein.

E5. Terminating Views

A fifth aspect that may vary among embodiments of the presented techniques involves the termination of the views 518 of a view set 516 presented on a shared display 104. For example, a device may receive a merge request to merge a group view 402 and an individual view 404, and may terminates at least one of the group view and the individual view of the content.

As a first variation of this fifth aspect, a view 518 may be terminated in response to a specific request by a user 102 interacting with the view 518, such as a Close button or a Terminate View verbal command. Alternatively, one user 102 may request to expand a particular view 518 in a manner that encompasses the portion of the display 104 that is allocated to another view 518, which may be terminated in order to utilize the display space for the particular view 518. For example, a device may receive a maximize operation that maximizes a maximized view 518 among the group view 402 and the individual view 404, and the device may respond by maximizing the maximized view and terminating at least one of the views 518 of the view set 516 that is not the maximized view.

As a second variation of this fifth aspect, while a first user 102 and an interacting user 522 are interacting with various views 518, one such user 102 may request a first perspective of one of the views 518 to be merged with a second perspective of another one of the views 518. The device may receive the merge request and respond by moving the second perspective to join the first perspective, which may also involve terminating at least one of the views 518 (since the two views 518 redundantly present the same perspective of the content 514).

As a third variation of this fifth aspect, a view 518 may be terminated due to idle usage. For example, a device may monitor an idle duration of the group view 402 and the individual view 404, and may identify an idle view for which an idle duration exceeds an idle threshold (e.g., an absence of interaction 524 with one view 518 for at least five minutes). The device may respond by terminating the idle view. In this manner, the device may automate the termination of various views 518 of the view set 516 in accordance with the techniques presented herein.

### F. Computing Environment

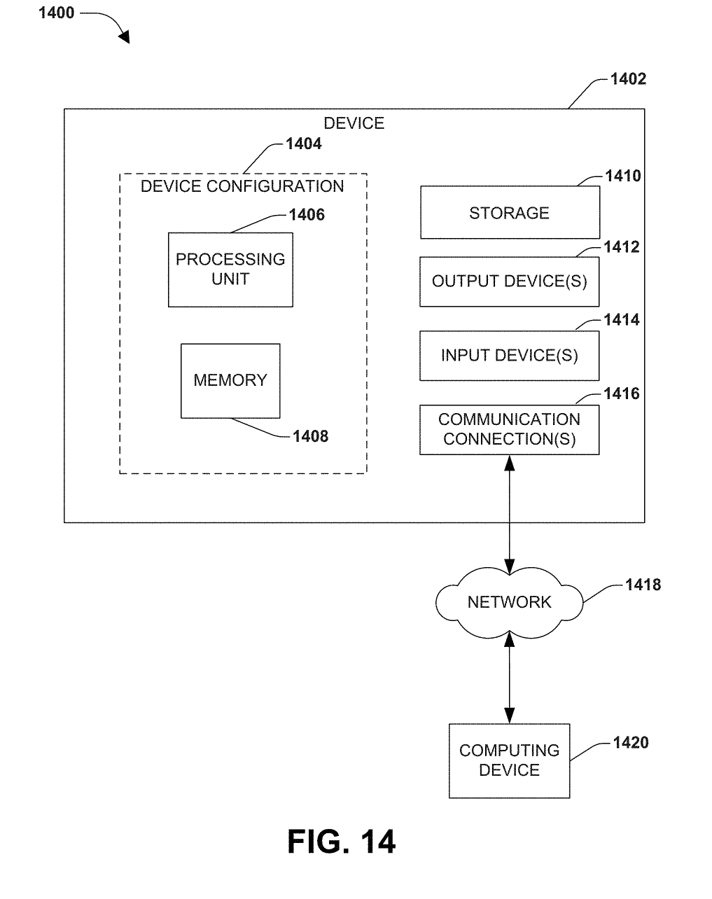

FIG. 14 and the following discussion provide a brief, general description of a suitable computing environment to implement embodiments of one or more of the provisions set forth herein. The operating environment of FIG. 14 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 14 illustrates an example of a system 1400 comprising a computing device 1402 configured to implement one or more embodiments provided herein. In one configuration, computing device 1402 includes at least one processing unit 1406 and memory 1408. Depending on the exact configuration and type of computing device, memory 1408 may be volatile (such as RAM, for example), non-volatile (such as ROM, flash memory, etc., for example) or some combination of the two. This configuration is illustrated in FIG. 14 by dashed line 1404.

In other embodiments, device 1402 may include additional features and/or functionality. For example, device 1402 may also include additional storage (e.g., removable and/or non-removable) including, but not limited to, magnetic storage, optical storage, and the like. Such additional storage is illustrated in FIG. 14 by storage 1410. In one embodiment, computer readable instructions to implement one or more embodiments provided herein may be in storage 1410. Storage 1410 may also store other computer readable instructions to implement an operating system, an application program, and the like. Computer readable instructions may be loaded in memory 1408 for execution by processing unit 1406, for example.

The term “computer readable media” as used herein includes computer storage media. Computer storage media includes volatile and nonvolatile, removable and non-removable media implemented in any method or technology for storage of information such as computer readable instructions or other data. Memory 1408 and storage 1410 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1402. Any such computer storage media may be part of device 1402.

Device 1402 may also include communication connection(s) 1416 that allows device 1402 to communicate with other devices. Communication connection(s) 1416 may include, but is not limited to, a modem, a Network Interface Card (NIC), an integrated network interface, a radio frequency transmitter/receiver, an infrared port, a USB connection, or other interfaces for connecting computing device 1402 to other computing devices. Communication connection(s) 1416 may include a wired connection or a wireless connection. Communication connection(s) 1416 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1402 may include input device(s) 1414 such as keyboard, mouse, pen, voice input device, touch input device, infrared cameras, video input devices, and/or any other input device. Output device(s) 1412 such as one or more displays, speakers, printers, and/or any other output device may also be included in device 1402. Input device(s) 1414 and output device(s) 1412 may be connected to device 1402 via a wired connection, wireless connection, or any combination thereof. In one embodiment, an input device or an output device from another computing device may be used as input device(s) 1414 or output device(s) 1412 for computing device 1402.

Components of computing device 1402 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1402 may be interconnected by a network. For example, memory 1408 may be comprised of multiple physical memory units located in different physical locations interconnected by a network.

Those skilled in the art will realize that storage devices utilized to store computer readable instructions may be distributed across a network. For example, a computing device 1420 accessible via network 1418 may store computer readable instructions to implement one or more embodiments provided herein. Computing device 1402 may access computing device 1420 and download a part or all of the computer readable instructions for execution. Alternatively, computing device 1402 may download pieces of the computer readable instructions, as needed, or some instructions may be executed at computing device 1402 and some at computing device 1420.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method that presents content by a device having a processor and a display that is shared by at least two users, the method comprising:
executing, by the processor, instructions that cause the device to:
initiate a presentation comprising a group view of the content;
receive, from an interacting user selected from the at least two users, a request to alter the presentation of the content;
insert into the presentation an individual view of the content for the interacting user;
receive an interaction from the interacting user that alters the presentation of the content; and
apply the interaction to the individual view of the content while refraining from applying the interaction to the presentation of the content in the group view.

2. The method of claim 1, wherein:
the interaction request from the interacting user further comprises a selection, by the interacting user, of a display location on the display; and
inserting the individual view further comprises inserting the individual view at the display location on the display.

3. The method of claim 1, wherein inserting the individual view further comprises:
maintaining a set of boundaries of the group view of the content; and
inserting the individual view as an inset view within the set of boundaries of the group view.

4. The method of claim 1, wherein inserting the individual view further comprises:
detecting a physical location of the interacting user;
choosing a display location on the display that is physically proximate to the physical location of the interacting user; and
presenting the individual view at the display location.

5. The method of claim 1, wherein executing the instructions further causes the device to:
detect a change of a physical location of the interacting user to a current physical location;
choose an updated display location on the display that is physically proximate to the current physical location of the interacting user; and
reposition the individual view at the updated display location.

6. The method of claim 1, wherein:
a selected view further comprises a focus on a selected portion of the content; and
executing the instructions further causes the device to choose a view size for the selected view according to the focus on the selected portion of the content.

7. A method of presenting content by a device having a processor and a display that is shared by at least two users, the method comprising:
executing, by the processor, instructions that cause the device to:
initiate on the display a view set of views that respectively display a presentation of the content;
receive an interaction that alters the presentation of the content;
identify, among the at least two users, an interacting user who initiated the interaction;
among the views of the view set, identify an individual view that is associated with the interacting user; and
apply the interaction to alter the presentation of the content by the individual view while refraining from applying the interaction to the presentation of the content by other views of the view set.

8. The method of claim 7, wherein:
the interaction from the interacting user further comprises an interaction dynamic degree; and
executing the instructions further causes the device to choose a view size for the individual view according to the interaction dynamic degree of the interaction with the individual view.

9. The method of claim 7, wherein:
the device further comprises a set of input devices that are respectively associated with a user of the at least two users; and
identifying the interacting user further comprises:
identifying, among the set of input devices, an interacting input device that received user input comprising the interaction; and
identifying, among the at least two users, the interacting user that is associated with the interacting input device.

10. The method of claim 7, wherein:
executing the instructions further causes the device to observe actions by the at least two users; and
identifying the interacting user further comprises:
identifying, among the actions observed by the device, a selected action that initiated the request; and
identifying, among the at least two users, the interacting user that performed the action that initiated the request.

11. The method of claim 7, wherein executing the instructions further causes the device to:
receive, from an overriding user of the users of the at least two users, an overriding request to interact with an overridden view that is not associated with the overriding user; and
fulfill the overriding request by applying interactions from the overriding user to the presentation of the content within the overridden view.

12. The method of claim 7, wherein:
the views of the view set respectively present a perspective within the content; and
executing the instructions further causes the device to insert, into the presentation, a map that illustrates the perspectives of the respective views of the view set.

13. The method of claim 7, wherein:
the presentation of the content is initially confined by a content boundary; and
executing the instructions further causes the device to:
receive, from the interacting user, an expanding request to view a peripheral portion of the content that is beyond the content boundary; and
expand the content boundary to encompass the peripheral portion of the content

14. A device that presents content to at least two users, the device comprising:
a processor; and
a memory storing instructions that, when executed by the processor, provide a system comprising:
a content presenter that:
initiates, on a display that is shared by the at least two users, a presentation comprising a group view of the content;
receives a request, from an interacting user selected from the at least two users, to alter the group view of the content; and
inserts into the presentation an individual view of the content for the interacting user; and
a view manager that:
receives an interaction from the interacting user that alters the presentation of the content; and
applies the interaction to the individual view of the content while refraining from applying the interaction to the presentation of the content in the group view.

15. The device of claim 14, wherein the view manager further:
receives, from the interacting user, a modification of the content; and
presents the modification in the group view of the content for the first user.

16. The device of claim 14, wherein the view manager further:
receives, from the interacting user, a modification of the content;
bifurcates the content into an unmodified version and a modified version that incorporates the modification;
presents the unmodified version of the content in the group view; and
presents the modified version of the content in the individual view.

17. The device of claim 14, wherein the view manager further:
receives a merge request to merge the group view and the individual view; and
terminates at least one of the group view and the individual view of the content.

18. The device of claim 17, wherein:
the merge request further comprises a maximize operation that maximizes a maximized view among the group view and the individual view; and
terminating the at least one of the group view and the individual view further comprises:
maximizing the maximized view; and
terminating one of the group view and the individual view that is not the maximized view.

19. The device of claim 17, wherein:
the group view further comprises a first perspective of the content, and the individual view further comprises a second perspective of the content;
receiving the merge request further comprises: receiving a merge request to move the second perspective to join the first perspective; and
the view manager further moves the second perspective to join the first perspective.

20. The device of claim 14, wherein the view manager further:
monitors an idle duration of the group view and the individual view;
identifies, among the group view and the individual view, an idle view for which the idle duration exceeds an idle threshold; and
terminates the idle view.
